(19) United States
(12) Patent Application Publication
(10) Pub. No.: US 2019/0311591 A1
(43) Pub. Date: Oct. 10, 2019

(54) FIRE EXTINGUISHER MONITORING SYSTEM AND METHOD

(71) Applicant: Pattern Analytics Ltd, Solihull; West Midlands (GB)

(72) Inventors: Glyn Martin Adgie, Birmingham; West Midlands (GB); Gregory Michael Reynolds, Birmingham; West Midlands (GB); Michael Thomas Bryant, Southampton; Hampshire (GB)

(21) Appl. No.: 16/315,136

(22) PCT Filed: Aug. 4, 2017
(86) PCT No.: PCT/GB2017/052295

§ 371 Date: Jan. 3, 2019

(30) Foreign Application Priority Data
Aug. 10, 2016 (GB) 1613737.4

(51) Int. Cl. G08B 13/14; A62C 13/78

(52) U.S. Cl. CPC G08B 13/149; A62C 13/78

(57) ABSTRACT

A fire extinguisher monitoring system is described, said fire extinguisher monitoring system comprising a magnetic member for attachment to a fire extinguisher, a magnet, and a magnetic field sensor, wherein said magnetic field sensor is located proximal to said magnet to detect the presence of said magnetic member in said magnet's magnetic field. A method of monitoring the location of a fire extinguisher is also described.

This application is a national stage entry under 35 U.S.C. § 371 of International Application No. PCT/GB2017/052295, filed Aug. 4, 2017, which claims the benefit of GB Application No. 1613737.4, filed Aug. 10, 2016. The entire contents of International Application No. PCT/GB2017/052295 and GB Application No. 1613737.4 are incorporated herein by reference.

### TECHNICAL FIELD

The present disclosure relates to a fire extinguisher monitoring system, and more particularly to a fire extinguisher monitoring system that uses magnetic sensing means.

### BACKGROUND

Fire extinguisher monitoring (FEM) systems are commonly used to detect when a fire extinguisher has been moved from its usual storage place, and to signal or log these events such that appropriate action may be taken. Most commonly these actions include the sounding of an alarm and/or triggering of a sprinkler system, alongside creating a record of the movement of the fire extinguisher in a database. As a fire extinguisher must be available for emergency use, it is essential that any FEM system does not interfere with, or slow, legitimate operation of a fire extinguisher.

In the state of the art, FEM systems typically include a connection between a fire extinguisher and a processing unit, this processing unit most usually attached to a wall or fire trolley. The connection between the processing unit and the fire extinguisher is frangible, allowing the facile removal of the fire extinguisher if its use is required. As such, the immediate and urgent use of the fire extinguisher by a user is not hampered, and the FEM system is compliant with all laws related to the provision of fire extinguishers.

The disruption of the frangible connection between the fire extinguisher and the processing unit results in the concomitant disruption of a parameter monitored by the processing unit. In the state of the art, the frangible connection commonly comprises a plug and a socket, with the parameter to be monitored by the processing unit being a measured electric current.

For example, one such system included in the state of the art may comprise an electrical wire with a single pole plug at each end. In this case, the processing unit will have two sockets, into which the single pole plugs are inserted after the wire is placed around a fire extinguisher. In this way, when the fire extinguisher is removed, the wire is pulled and the plugs are disconnected from the sockets. In this implementation, the processing using would monitor the current passing round a circuit including the sockets, and sound an alarm if this electrical circuit was broken.

Whilst, at first instance, the state of the art appears to allow for the provision of a satisfactory FEM system, the present applicants have become aware of several disadvantages of the systems included in the state of the art. Firstly, the use of a plug and socket design may not result in the disruption of the connection between the fire extinguisher and the processing unit unless the fire extinguisher is removed by a user in a defined direction. In this case, any attempt by the designer of the FEM system to ensure the user removes the fire extinguisher in the defined direction can result in significant increases in the difficulty of its removal, and the potential violation of relevant safety laws.

Additionally, the use of sockets requires the provision of apertures in the housing containing the processing unit. Therefore, as is commonly the case, if the FEM system is to be installed outdoors then waterproofing and weatherproofing will be required around the sockets. Without any such provision, water ingress and the corrosion of contacts can present significant issues.

Additionally, it is often necessary to power outdoor units with a battery, and the use of an electrical circuit to monitor the position of a fire extinguisher may result in a significant battery drain. To be compliant with current standards, any remote unit requires a battery life of at least three years, representing a significant obstacle in the provision of a system based on the detection of an electrical current.

### SUMMARY

According to a first aspect of the present invention, there is provided a fire extinguisher monitoring system, said fire extinguisher monitoring system comprising; a magnetic member for attachment to a fire extinguisher, a magnet, and a magnetic field sensor, wherein said magnetic field sensor is located proximate said magnet to detect the presence of said magnetic member in said magnet's magnetic field.

In this way, there is provided a fire extinguisher monitoring system capable of detecting the removal of a fire extinguisher from a set location using magnetic sensing means.

Preferably, the magnet has at least one line of symmetry. More preferably, the magnet has at least two lines of symmetry. Still more preferably, the magnet has at least three lines of symmetry. It may also be preferable for the magnet to have at least one axis of rotational symmetry.

Preferably, the magnetic field sensor is positioned to detect changes in the magnet's magnetic field in the same plane as a line of symmetry of the magnet. Alternatively, it may be preferable for the magnetic field sensor to be positioned to detect changes in the magnet's magnetic field in a plane perpendicular to a line of symmetry of the magnet. It may also be preferable for the magnetic field sensor to be positioned to detect changes in the magnet's magnetic field in a plane parallel to an axis of rotational symmetry of the magnet.

Preferably, the magnet and the magnetic field sensor are located inside a housing. Preferably, a battery is also located inside the housing. Preferably, the housing is water resistant. More preferably, the housing is waterproof. Preferably, the housing is weatherproof. More preferably, the housing is frost proof and resistant to degradation from UV light.

Preferably, the fire extinguisher monitoring system further comprises a first processing unit in communication with the magnetic field sensor. Preferably, the first processing unit is located in the housing. Preferably the first processing unit comprises an integrated circuit.

Preferably, the first processing unit is in communication with a first alarm. Preferably the first alarm comprises an aural component. Preferably the first alarm comprises a visual component. Most preferably, the first alarm comprises both an aural and visual component.

Preferably, the first processing unit is in communication with a transmitter. Preferably, the transmitter transmits a signal using radio waves. More preferably, the transmitter transmits a signal over a Wi-Fi (RTM) connection. Preferably the transmitter is located within the housing.

Preferably, the transmitter relays a signal from the magnetic field sensor to a receiver remote from said transmitter. Preferably, the receiver is in communication with a second processing unit. Preferably, the second processing unit comprises an integrated circuit.

Preferably, the second processing unit is in communication with a second alarm. Preferably the second alarm comprises an aural component. Preferably the second alarm comprises a visual component. Most preferably, the second alarm comprises both an aural and visual component. Preferably, the second alarm is activated simultaneously with the first alarm.

Preferably, the second processing unit is in communication with means for recording the status of a fire extinguisher. Preferably, the means for recording the status of a fire extinguisher is a computer. More preferably, the means for recording the status of a fire extinguisher is a database on a computer.

Preferably, the fire extinguisher monitoring system further comprises a fire extinguisher. Preferably, the magnetic member is attached to the fire extinguisher by an attachment member. Preferably, the attachment member is in the shape of a ring or loop. Preferably, the attachment member is flexible and substantially inextensible.

Preferably the magnet comprises Neodymium Iron Boron. Preferably the magnet comprises Samarium Cobalt.

According to a second aspect of the present invention, there is provided a method of monitoring the location of a fire extinguisher using the apparatus as already described, comprising; monitoring said magnetic field using said magnetic field sensor, positioning said magnetic member for attachment to a fire extinguisher within said magnetic field, and detecting a variation in said magnetic field caused by the movement of said magnetic member within said magnetic field.

In this way, a method of monitoring the position of a fire extinguisher is provided.

When the method of the second aspect uses the apparatus of the first aspect having said first processing unit in communication with a first alarm, the method preferably comprises the further step of activating said first alarm in response to the detection of a variation in the magnetic field.

When the method of the second aspect uses the apparatus of the first aspect having said second processing unit in communication with a second alarm, the method preferably comprises the further step of activating said second alarm in response to the detection of a variation in the magnetic field.

Preferably, the method comprises the further step of recording the variation in the magnetic field. Preferably, this recording notes instances where the measure magnet field moves above or below a set threshold.

According to a third aspect of the present invention, there is provided a fire extinguisher monitoring system substantially as hereinbefore described with reference to the accompanying drawings.

According to a fourth aspect of the present invention, there is provided a method of monitoring the location of a fire extinguisher, substantially as hereinbefore described with reference to the accompanying drawings.

### BRIEF DESCRIPTION OF THE DRAWINGS

Embodiments of the present disclosure_will now be described by way of example only and with reference to the accompanying drawings.

FIG. 1 is a schematic view of the exterior of an embodiment of an FEM system in accordance with the present invention.

FIG. 2 is a schematic view of the magnetic member, first processing unit and magnet of in an embodiment of an FEM system in accordance with the present invention.

FIG. 3 is a schematic illustration of the magnetic field in the absence of the magnetic member in an embodiment of an FEM system in accordance with the present invention.

FIG. 4 is a schematic illustration of the magnetic field in the presence of the magnetic member in an embodiment of an FEM system in accordance with the present invention.

FIG. 5 is a schematic illustration of the connectivity between components of the FEM system.

FIG. 6 is a flow diagram schematically illustrating the operation of the FEM system.

### DETAILED DESCRIPTION

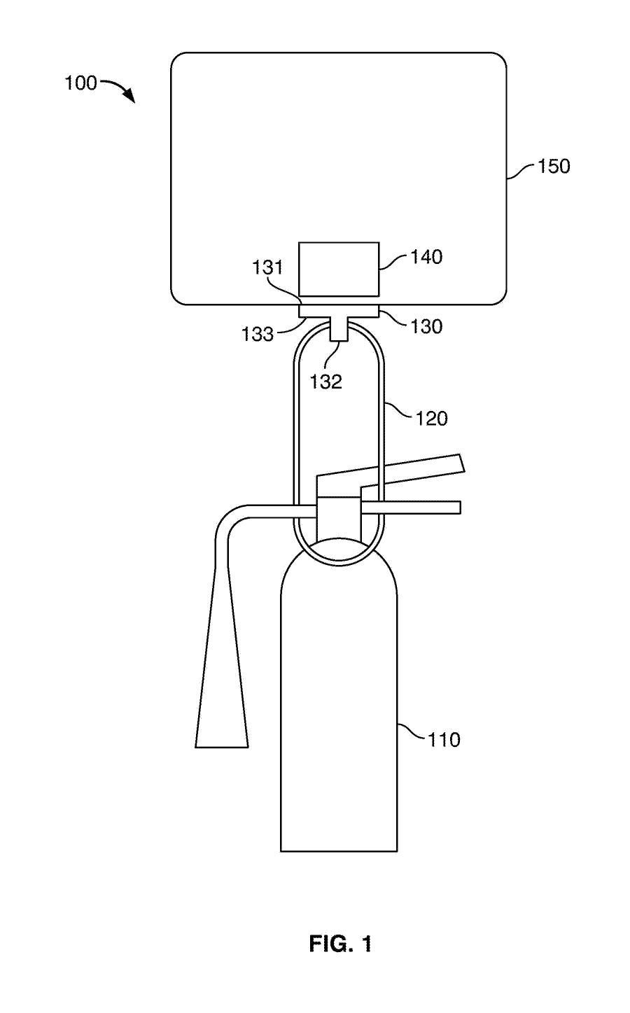

Referring to FIG. 1 of the drawings, there is shown an FEM system 100 in accordance with the present invention. Here, the FEM system 100 comprises a fire extinguisher 110, an attachment member 120, a magnetic member 130 and a housing 140 located within a structure 150. Here, the fire extinguisher 110 is depicted as a discharge fire extinguisher, although the term fire extinguisher should also be construed to include any equipment designed to extinguish a fire, such as a fire blanket.

The magnetic member 130 may comprise any magnetic material such as nickel, iron or cobalt, and is formed in the shape of a plate, with a substantially planar front surface 131. The magnetic member further comprises a finger 132 extending from the rear surface 133 of the plate, the finger 132 further comprising an eyelet 134. The magnetic member 130 is attached or connected to the fire extinguisher 110 via the attachment member 120. This attachment member 120 is threaded through the eyelet 132 of the magnetic member 130 and around the fire extinguisher 110 to form a loop or ring structure. The attachment member 120 comprises a resilient and flexible material, in this case a nylon cord, although the use of other materials or the use of a chain formed of metal or plastic links is also envisaged. The attachment member 120 forms a secure connection between the fire extinguisher 110 and the magnetic member 130.

The housing 140, is located within a structure 150 such as a wall, pillar or floor in a location where it is desirable for a fire extinguisher to be located in close proximity. The structure 150 may also be a component of a fire trolley or similar if it is desirable for the fire extinguisher 110 to be mobile. The housing 140 comprises a shell of non-magnetic material, this shell enclosing a magnet, a magnetic field sensor and a first processing unit for controlling the operation of the magnetic field sensor. The housing 140 protects the magnet, magnetic field sensor and first processing unit from external impacts. Additionally, the housing 140 is resistant to water ingress and assists in protecting the components located inside the housing from atmospheric conditions.

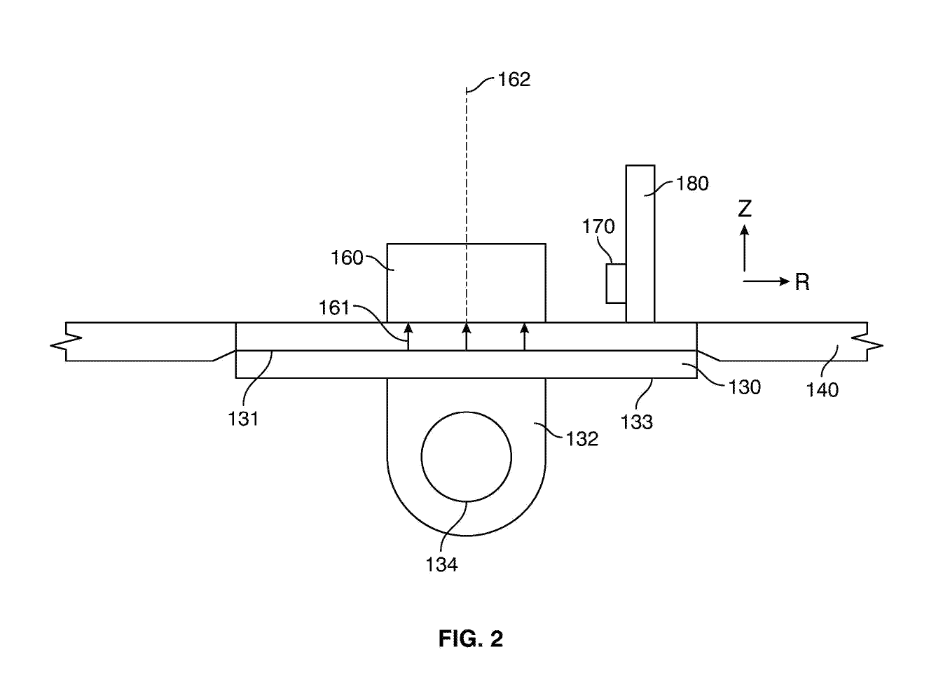

Referring now to FIG. 2, the relationship of the housing 140 to the magnetic member 130 is more clearly illustrated. Additionally, the central position of the finger 132 on the rear surface 133 of the magnetic member 130 can be seen more clearly, along with the position of the eyelet 134 in relation to the finger 132. It can also be seen that the eyelet 134 is circular in shape, forming a cylindrical aperture through the finger 132.

As can be seen in FIG. 2, in operation, the magnetic member 130 is located substantially opposite the magnet 160, with the shell of the housing 140 forming a barrier preventing direct contact between the magnetic member 130 and the magnet 160. The magnetic member 130 is held in place by the magnetic field of the magnet 160, illustrated by arrows 161. Additionally, it can be seen that the magnet has a line of symmetry 162 lying perpendicular to the front surface 131 of the magnetic member. As the magnet 160 has a line of symmetry, in the absence of any external influence the magnetic field of the magnet 160 will also be symmetrical around this axis.

The magnet 160 can be made of any ferromagnetic or ferrimagnetic material. Here, the magnet 160 is required to hold the magnetic member 130 in place through the shell of the housing 140. As such, a strong, permanent magnet is used, comprising Neodymium Iron Boron and/or Samarium Cobalt.

A magnetic field sensor 170 is also located inside the housing 140, within the magnetic field generated by the magnet 160. The magnetic field sensor 170 is located on a first processing unit 180, the first processing unit also located within the housing 140. The first processing unit 180 is in communication with the magnetic field sensor 170, and is involved with processing the signals generated by the magnetic field sensor 170. Additionally, the first processing unit 180 comprises a battery to ensure the FEM system remains operational without the need for an external power source. Here, the magnetic sensor 170 is a semiconductor that detects variations in the magnetic field using the Hall Effect.

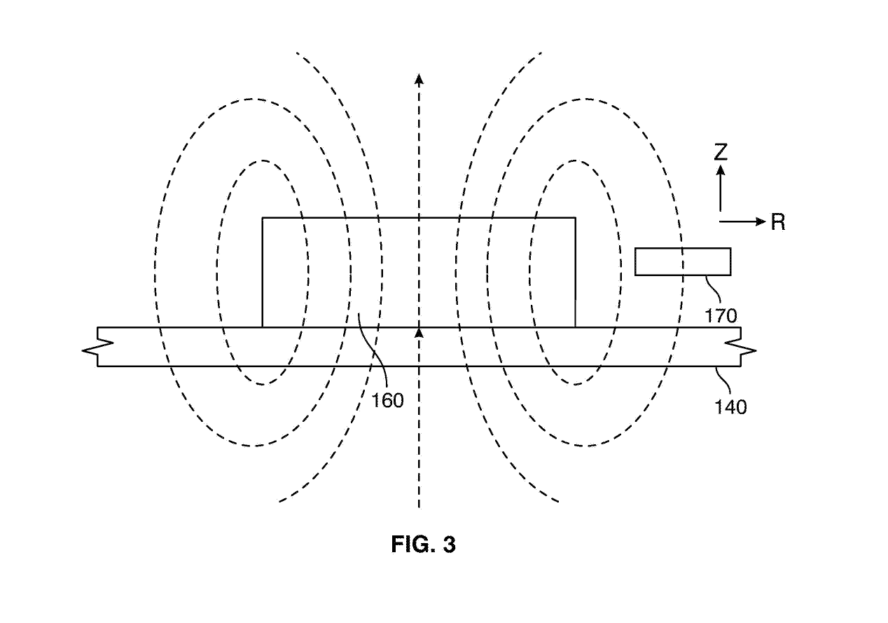

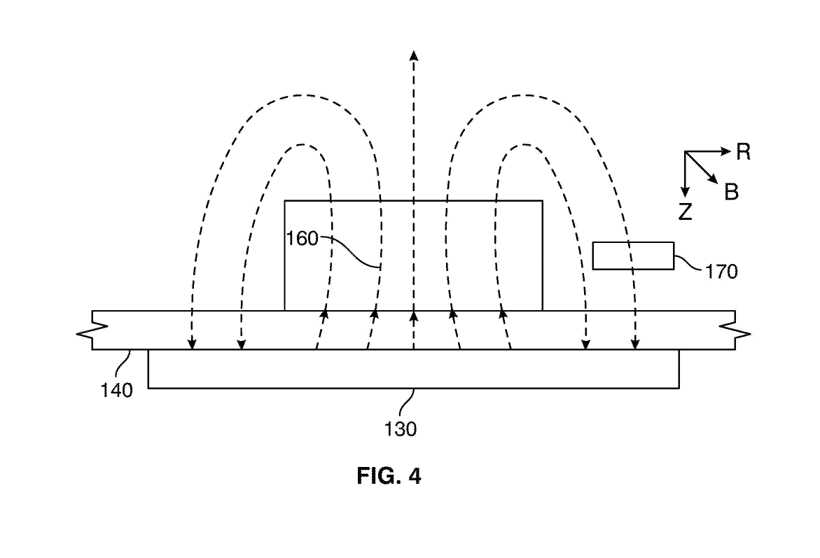

As depicted in FIG. 2, the magnetic field sensor 170 is positioned to detect a magnetic field in the direction marked R in FIG. 2. Additionally, in this orientation, the magnetic field sensor is positioned to be insensitive to magnetic fields in the direction marked Z. In this way, the form of the magnetic field may be detected by the magnetic field sensor 170, the transition between these states dictated by the presence or absence of the magnetic member 130 from a location proximal to the magnet 160. The variations in the form of the magnetic field are discussed in more detail in relation to FIGS. 3 and 4.

FIG. 3 depicts the magnetic field lines (represented by dashed lines) associated with the magnet 160 where the magnetic member 130 is not located in a position proximate magnet 160. Here, the housing 140 does not comprise any magnetic material, and thus does not influence the magnetic field. Here, it can be seen that where the magnetic member 130 is absent, the magnetic field sensor 170 is not exposed to a magnetic field in the R direction. As, the magnetic field sensor 170 is only sensitive to fields in the R direction, it does not register the presence of a magnetic field from the magnet 160 under these conditions.

FIG. 4 depicts the magnetic field lines (represented by dashed lines) associated with the magnet 160 where the magnetic member 130 is located in a position proximate magnet 160. In this case, the presence of the magnetic member 130 in a location proximate the magnet 160 creates a disturbance in the magnetic field. This disturbance in the magnetic field results in the field experienced by the magnetic field sensor 170 having a vector aligned with B, as indicated in FIG. 4. As vector B has a component in the R direction, this magnetic field will be detected by the magnetic field sensor 170 for as long as the magnetic member 130 remains proximate the magnet 160.

Therefore, as can be seen from FIGS. 3 and 4, the presence or absence of the magnetic member 130 affects the magnetic field detected by the magnetic field sensor 170. Whilst the magnetic member 130 is proximate the magnet 160, the magnetic field sensor 170 can detect a magnetic field in the R direction. As soon as the magnetic member is removed, the magnetic field laying across the magnetic field detector 170 lies wholly in the Z direction and, as such, the magnetic field detector 170 no longer registers the presence of a magnetic field. These changes in the state of the magnetic field are communicated by the magnetic field detector 170 to the first processing unit 180. As such, any removal of the fire extinguisher 110, and therefore the attached magnetic member 130, will result in the magnetic field sensor 170 no longer detecting the presence of a magnetic field, and the communication of this change to the first processing unit 180.

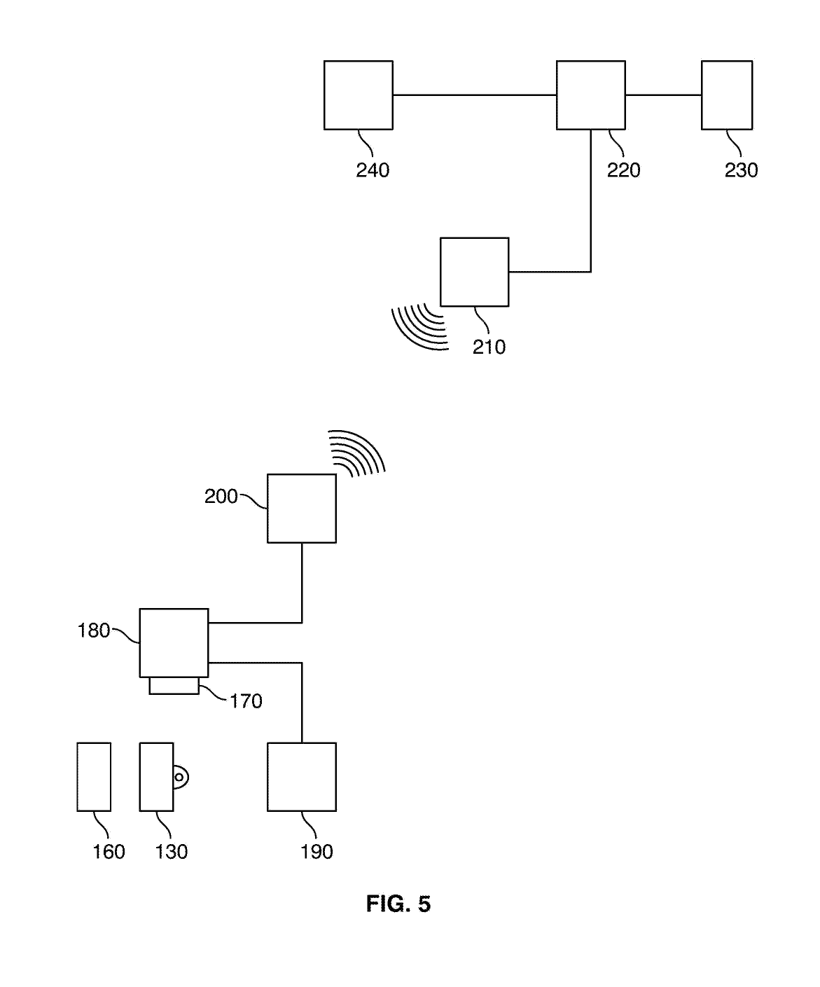

As can be seen in FIG. 5, the movement of the magnetic member 130 to a position distant from the magnet 160 may result in many further actions being undertaken. The first processing unit is in communication with a first alarm 190, this first alarm 190 located proximate the location of the fire extinguisher 110. In this case, if a user removes the fire extinguisher 110 from its storage location, an alarm will be triggered in the user's immediate vicinity. The first alarm 190 includes both aural and visual components, in the present case the alarm comprising an audible siren and a flashing light.

The first processing unit 180 is also in communication with a transmitter 200. In the event the removal of the fire extinguisher 110 is detected, the transmitter 200 receives a signal from the magnetic field sensor 170, via the first processing unit 180, and broadcasts this signal to a location remote from the fire extinguisher 110. At this remote location, a receiver 210 receives the signal from the transmitter 200. The signal is communicated from the transmitter 200 to the receiver 210 via wireless technology, in this case across a Wi-Fi (RTM) network.

The receiver 210 is in communication with a second processing unit 220. This second processing unit 220 receives the signal from the receiver 210, and relays it on to other components of the FEM system 100. The second processing unit 220 is in communication with a second alarm 230, the second alarm located remotely from the location of the fire extinguisher 110. Again, as with the first alarm 190, the second alarm 230 has both visual and aural components to alert a person in a location remote from any fire extinguisher 100 that a fire extinguisher has been removed, this person most usually located in a control room or central office.

Additionally, the second processing unit 220 is connected to apparatus for recording the status of the fire extinguisher 110. In FIG. 5, this apparatus is depicted as a computer 240, the computer containing a database capable of recording the status of all fire extinguishers connected to the FEM system 100. This database is in continuous operation on the computer 240, and may be used by any person to monitor the status of all fire extinguishers at a present time. Additionally, the database contains information related to the past status of all fire extinguishers, and information regarding any further actions required in relation to any fire extinguisher. This data may include a record of any previous removals of any individual fire extinguisher, the maintenance records of each fire extinguisher, and the next maintenance date for any fire extinguisher.

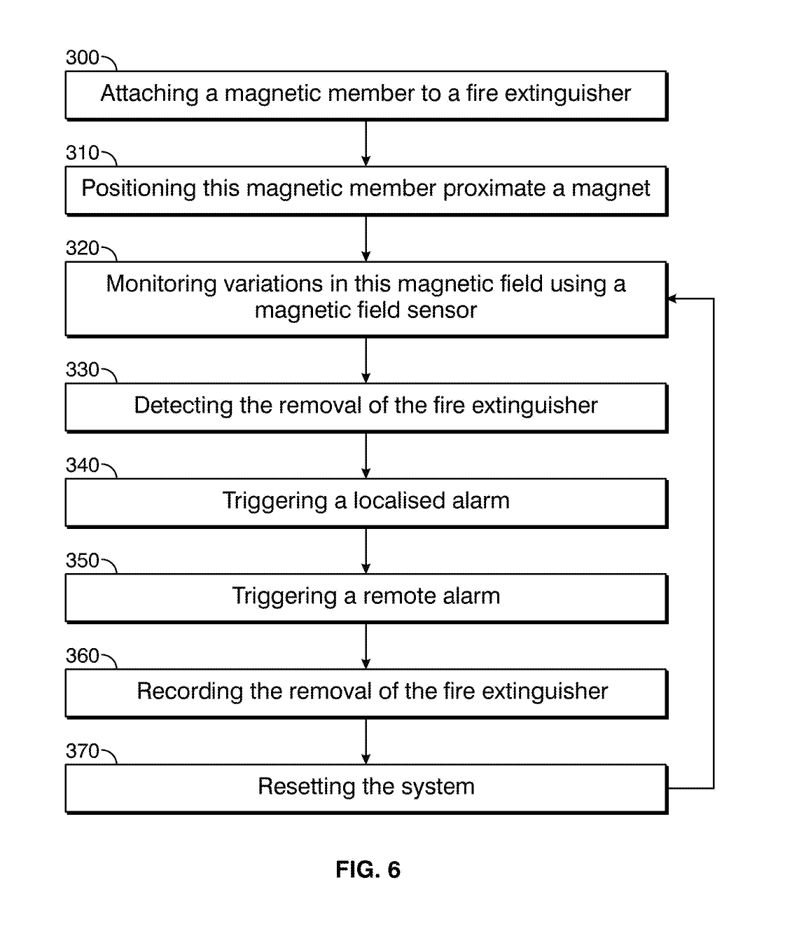

FIG. 6 illustrates a typical method of operation of the FEM system 100. During the operation of the FEM system, a magnetic member is attached to a fire extinguisher 300, and this magnetic member is placed proximate a magnet of the FEM system 310. Subsequently, a magnetic field sensor included in the FEM system is used to monitor the magnetic field in the area surrounding the magnet and magnetic member 320.

During this monitoring process, if the magnetic field sensor detects a variation in this magnetic field greater than a predetermined set point, and for a time period longer than a predetermined limit, the FEM system will assume the fire extinguisher has been removed 330 and will trigger a localised alarm 340. In addition to the triggering of a local alarm, the FEM system will trigger an alarm remote from the location of the fire extinguisher 350 and record the removal of a fire extinguisher on a computer database 360.

To cease the alarm, the FEM system must be reset 370. This is accompanied by both the replacement of the magnetic member in a location proximate the magnet of the FEM system, and the resetting the alarm at a control panel. The control panel may be located close to the fire extinguisher, or in the case of a large scale FEM system, in a centralised location. After the FEM system has been reset, the system once again monitors variation in the magnetic field 320, monitoring for any subsequent removal of the fire extinguisher 330.

Various modifications may be made to the described embodiment without departing from the scope of the present invention. The structure and orientation of the apparatus may be of an alternative design and shaping, there may be one or more loops and one or more magnets. The apparatus may comprise any suitable material or construction. One monitoring system may extend to more than one fire extinguisher.

1. A fire extinguisher monitoring system, said fire extinguisher monitoring system comprising;
a magnetic member for attachment to a fire extinguisher,
a magnet, and
a magnetic field sensor, wherein the magnetic field sensor is located proximate said magnet to detect the presence of said magnetic member in said magnet's magnetic field.

2. The fire extinguisher monitoring system according to claim 1, wherein the magnet has at least one line of symmetry.

3. The fire extinguisher monitoring system according to claim 2, wherein the magnetic field sensor is positioned to detect changes in the magnet's magnetic field in the same plane as a line of symmetry of the magnet.

4. The fire extinguisher monitoring system according to claim 1, wherein the magnet and the magnetic field sensor are located inside a housing.

5. The fire extinguisher monitoring system according claim 4, wherein the housing is waterproof.

6. The fire extinguisher monitoring system according to claim 4, wherein the housing is weatherproof.

7. The fire extinguisher monitoring system according to claim 1, wherein the fire extinguisher monitoring system further comprises a first processing unit in communication with the magnetic field sensor.

8. The fire extinguisher monitoring system according to claim 7, wherein the first processing unit is in communication with a first alarm.

9. The fire extinguisher monitoring system according to claim 7, wherein the first processing unit is in communication with a transmitter.

10. The fire extinguisher monitoring system according to claim 9, wherein the transmitter relays a signal from the magnetic field sensor to a receiver remote from the transmitter.

11. The fire extinguisher monitoring system according to claim 10, wherein the receiver is in communication with a second processing unit.

12. The fire extinguisher monitoring system according to claim 11, wherein the second processing unit is in communication with a second alarm.

13. The fire extinguisher monitoring system according to claim 11, wherein the second processing unit is in communication with means for recording the status of a fire extinguisher.

14. The fire extinguisher monitoring system according to claim 1, wherein the fire extinguisher monitoring system further comprises a fire extinguisher.

15. The fire extinguisher monitoring system according to claim 14, wherein the magnetic member is attached to said fire extinguisher by an attachment member.

16. The method of monitoring the location of a fire extinguisher using the apparatus of claim 1, comprising;
monitoring the magnetic field using said magnetic field sensor,
positioning the magnetic member for attachment to a fire extinguisher within the magnetic field, and
detecting a variation in said magnetic field caused by the movement of the magnetic member within the magnetic field.

17. The method of monitoring the location of a fire extinguisher according to claim 16, further comprising activating said the first alarm in response to the detection of the variation in the magnetic field.

18. The method of monitoring the location of a fire extinguisher according to claim 16, further comprising activating the second alarm in response to the detection of the variation in the magnetic field.

19. The method of monitoring the location of a fire extinguisher according to claim 16, further comprising recording the variation in the magnetic field.
